(19) United States
(12) Patent Application Publication
(10) Pub. No.: US 2022/0176764 A1
(43) Pub. Date: Jun. 9, 2022

(54) VEHICLE

(71) Applicant: KYB Corporation, Minato-ku, Tokyo (JP)

(72) Inventors: Takahisa MOCHIZUKI, Minato-ku, Tokyo (JP); Takuhiro KONDO, Minato-ku, Tokyo (JP)

(73) Assignee: KYB Corporation, Minato-ku, Tokyo (JP)

(21) Appl. No.: 17/601,173

(22) PCT Filed: Mar. 25, 2020
(86) PCT No.: PCT/JP2020/013245

§ 371 Date: Oct. 4, 2021

(30) Foreign Application Priority Data
Apr. 10, 2019 (JP) 2019-074482

(51) Int. Cl. B60G 11/30; B60G 13/14

(52) U.S. Cl. CPC B60G 11/30; B60G 2202/24; B60G 2202/152; B60G 13/14

(57) ABSTRACT

Provided is a vehicle capable of suppressing an increase in weight. A vehicle includes an air suspension device (pneumatic apparatus), an accumulator, and an air pump. Compressed air is supplied to the air suspension device. The accumulator stores compressed air to be supplied to the air suspension device. The air pump is driven by a relative movement between a vehicle body and wheels, and generates compressed air to be stored in the accumulator.

### TECHNICAL FIELD

The present invention relates to a vehicle.

### BACKGROUND ART

Patent Literature 1 discloses a conventional vehicle including an air suspension device as a pneumatic apparatus. The air suspension device is a suspension device using an air spring. The air spring can change elastic repulsive force or adjust height of the vehicle by changing an amount of enclosed air.

### CITATIONS LIST

### Patent Literature

Patent Literature 1: JP 2009-298170 A

### SUMMARY OF INVENTION

### Technical Problems

In the case of Patent Literature 1, compressed air to be supplied to an air suspension device is generated by a compressor mounted on the vehicle. Thus, in order to supply compressed air to the pneumatic apparatus for the vehicle such as the air suspension device, a compressed air generation means such as the compressor is usually mounted on the vehicle, with the result that a weight of the vehicle is increased accordingly. In addition, when the compressor is mounted, it is also required to mount peripheral devices such as a filter and a dryer, which leads to a further increase of the weight of the vehicle.

The present invention has been made in view of the above-described conventional circumstances, and an object to be solved by the invention is to provide a vehicle capable of suppressing an increase in weight.

### Solutions to Problems

A vehicle of the present invention includes a pneumatic apparatus, an accumulator, and an air pump. Compressed air is supplied to the pneumatic apparatus. The accumulator stores compressed air to be supplied to the pneumatic apparatus. The air pump is driven by a relative movement between a vehicle body and wheels, and generates compressed air to be stored in the accumulator.

The vehicle of the present invention may be an electric vehicle.

The vehicle of the present invention may include a supply unit that supplies the compressed air to be stored in the accumulator from outside of the vehicle.

### BRIEF DESCRIPTION OF DRAWINGS

FIG. 1 is a diagram schematically illustrating a vehicle according to Embodiment 1.

FIG. 2 is a schematic diagram of a pneumatic circuit according to Embodiment 1.

### DESCRIPTION OF EMBODIMENT

An embodiment in which a vehicle of the present invention is embodied will be described with reference to the drawings. In the following description, an electric vehicle 1 is exemplified as a vehicle according to the present invention. The vehicle 1 is a so-called community vehicle whose main purpose of use is a short-distance travel with a round-trip distance of at most about several tens of kilometers, such as daily commuting and shopping.

### Embodiment 1

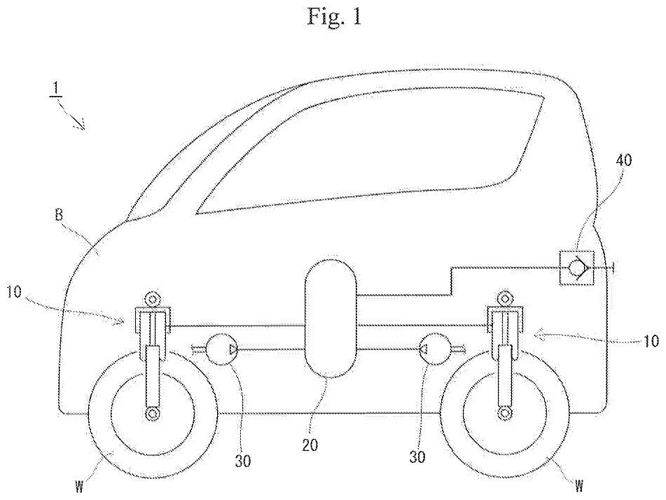

As illustrated in FIG. 1, the vehicle 1 of Embodiment 1 includes a vehicle body B and a plurality of wheels W. The vehicle 1 travels by driving at least any one of the wheels W by a drive unit (not illustrated) having a motor by being supplied with electric power from a battery unit (not illustrated).

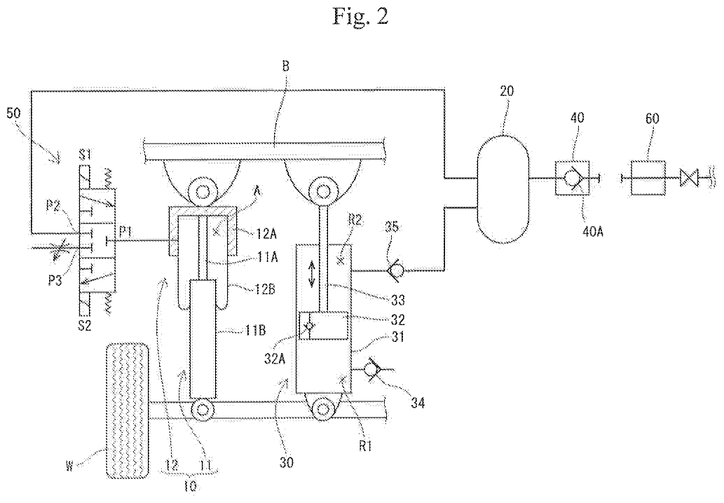

As illustrated in FIGS. 1 and 2, the vehicle 1 includes an air suspension device 10 (exemplified as a pneumatic apparatus according to the present invention), an accumulator 20, and an air pump 30. The vehicle 1 also includes a terminal 40 (exemplified as a supply unit according to the present invention) and an on-off control valve 50.

The air suspension device 10 is disposed between the vehicle body B and the wheels W. The air suspension device 10 is provided for each of the wheels W. As illustrated in FIG. 2, each air suspension device 10 includes a damper 11 and an air spring 12. The damper 11 is a hydraulic damper including a rod 11A and a cylinder 11B. The damper 11 is provided so as to be extensible/contractible, and both ends thereof are attached between the vehicle body B and the wheels W. The damper 11 extends/contracts in accordance with a relative movement between the vehicle body B and the wheels W to generate damping force for suppressing the relative movement.

The air spring 12 functions as a suspension spring that supports a weight of the vehicle body B. As illustrated in FIG. 2, the air spring 12 includes a bottomed cylindrical chamber 12A connected to the rod 11A of the damper 11, and a cylindrical diaphragm 12B connected to an opening of the chamber 12A and a cylinder 11B. In the air spring 12, an air chamber A in which compressed air is enclosed is formed by the chamber 12A and the diaphragm 12B. The compressed air inside the air chamber A is expanded/compressed in response to an impact or vibration input from a road surface, so that the air spring 12 extends/contracts. An extending/contracting direction of the air spring 12 is the same as an extending/contracting direction of the damper 11. The air spring 12 causes elastic repulsive force of the compressed air to act in an extending direction of the damper 11. In addition, the air spring 12 is provided so as to be extensible/contractible to a desired length according to an amount of the compressed air enclosed in the air chamber A. That is, the air suspension device 10 has a vehicle height adjustment function of adjusting a vehicle height to a desired height by freely adjusting a distance between the vehicle body B and the wheels W within a predetermined range by extending/contracting the air spring 12.

The accumulator 20 stores compressed air to be supplied to the air suspension device 10. The compressed air generated by the air pump 30 which will be described later is supplied to the accumulator 20. In addition, compressed air can be supplied from outside to the accumulator 20 by a terminal 40 which will be described later. As illustrated in FIG. 2, the accumulator 20 is connected to the air spring 12 of the air suspension device 10 via the on-off control valve 50 in a pneumatic circuit.

The accumulator 20 can store compressed air for adjusting the vehicle height of the vehicle 1 by the air suspension device 10 at least twice. In other words, the accumulator 20 is provided to be able to store the compressed air capable of performing a state change twice or more from a state in which pressure within the air chamber A is reduced to atmospheric pressure to a normal use state in which the weight of the vehicle body B is supported at a predetermined vehicle height.

The air pump 30 generates compressed air to be stored in the accumulator 20. The air pump 30 is driven by a relative movement between the vehicle body B and the wheels W. That is, the air pump 30 is driven using a force generated by a vertical movement occurring at the time of traveling of the vehicle 1 or the like as a drive source.

Specifically, as illustrated in FIG. 2, the air pump 30 in the present embodiment is disposed between the vehicle body B and the wheels W so as to be extensible/contractible. The air pump 30 includes a cylinder 31, a piston 32, and a rod 33. The cylinder 31 is formed in a bottomed cylindrical shape. One end of the cylinder 31 is coupled to the wheel W side. The piston 32 is housed in the cylinder 31. The piston 32 partitions a space in the cylinder 31 into a piston-side chamber R1 and a rod-side chamber R2, and is provided so as to be reciprocable along an inner wall of the cylinder 31. In addition, the piston 32 is formed with a communication passage which communicates between the piston-side chamber R1 and the rod-side chamber R2 and in which a check valve 32A is disposed. The check valve 32A allows a flow of air from the piston-side chamber R1 to the rod-side chamber R2, and blocks a flow opposite thereto. One end of the rod 33 is coupled to the vehicle body B side, and the other end is coupled to the piston 32 in the cylinder 31.

Further, the piston-side chamber R1 is formed with a communication passage which communicates between the piston-side chamber R1 and an outer space of the cylinder 31 and in which a check valve 34 is disposed. The check valve 34 allows a flow of air from the outer space toward the piston-side chamber R1, and blocks a flow opposite thereto. The rod-side chamber R2 is formed with a communication passage which communicates between the rod-side chamber R2 and a space in the accumulator 20 and in which a check valve 35 is disposed. The check valve 35 allows a flow of air from the rod-side chamber R2 toward the accumulator 20 side, and blocks a flow opposite thereto. In the thus-configured air pump 30, when a relative movement between the vehicle body B and the wheels W occurs, air is compressed through the piston-side chamber R1 and the rod-side chamber R2, and stored in the accumulator 20.

The terminal 40 supplies the compressed air to be stored in the accumulator 20 from outside of the vehicle 1. That is, the terminal 40 is a supply port for supplying compressed air from outside. An external terminal 60, which is a terminal on a compressed air supply source (not illustrated) side outside the vehicle 1, is detachably connected to the terminal 40. By connecting the external terminal 60 on the supply side to the terminal 40, a flow path from the air supply source to the accumulator 20 is formed. As a result, compressed air is supplied from the outside and stored in the accumulator 20. As illustrated in FIG. 2, the terminal 40 has a check valve 40A incorporated therein. The check valve 40A blocks a flow of compressed air from the accumulator 20 side. When the external terminal 60 is connected to the terminal 40, the check valve 40 is opened by pressure on the air supply source side, and allows compressed air to flow to the accumulator 20 side.

As illustrated in FIG. 2, the on-off control valve 50 is provided between the air spring 12 and the accumulator 20. The on-off control valve 50 is provided for each of the air suspension devices 10. Each on-off control valve 50 is a three-port, three-position electromagnetic valve having three ports P1, P2, and P3 and two solenoids S1 and S2. The on-off control valve 50 is opened and closed under the control of a control unit (nor illustrated) such as a vehicle ECU. In the on-off control valve 50, the air spring 12 is connected to a first port P1, the accumulator 20 is connected to a second port P2, and a third port P3 is opened to the atmosphere. In a first energization state in which the solenoid S1, which is one of two solenoids S1 and S2, is energized, the on-off control valve 50 allows communication between the first port P1 and the second port P2, which enables compressed air to be supplied from the accumulator 20 to the air spring 12. In a second energization state in which the solenoid 32, which is the other of the two solenoids S1 and S2, is energized, the on-off control valve 50 allows communication between the first port P1 and the third port P3, which enables the compressed air in the air spring 12 to be discharged to the outside. Further, when not energized, the on-off control valve 50 blocks communication between the first port P1 and the second and third ports P2 and P3.

Next, an operation of the vehicle 1 of Embodiment 1 will be described.

In the vehicle 1, compressed air to be supplied to the air suspension device 10 as a pneumatic apparatus is stored in the accumulator 20. The compressed air to be stored in the accumulator 20 is generated by the air pump 30. The air pump 30 is driven by a change in a distance between the vehicle body B and the wheels W due to vertical movement when the vehicle 1 travels or the like. Thus, the vehicle 1 can generate compressed air by the air pump 30 without mounting a compressed air generation means such as a compressor.

The vehicle 1 can also supply compressed air from the outside of the vehicle 1 to the accumulator 20 by the terminal 40. When compressed air is supplied from the outside to the accumulator 20, the external terminal 60 is connected to the terminal 40 (see FIG. 2 and the like). As a result, communication between the accumulator 20 and a compressed air supply source located outside is secured, and compressed air is supplied from the outside. After filling of the accumulator 20 with compressed air is completed, the connection between the terminal 40 and the external terminal 60 is released. At this time, since the terminal 40 has the check valve 40A, the compressed air in the accumulator 20 is prevented from spouting to the outside.

Note that, in the vehicle 1 which is an electric vehicle, it is preferable to supply (replenish) compressed air from the outside to the accumulator 20 simultaneously with charging. That is, in the vehicle 1, the accumulator 20 can be replenished with compressed air at the same time as charging of the battery unit if a compressed air supply source such as a compressor and the external terminal 60 connected thereto are arranged together in a charging facility installed in a highway service area, a gas station, a public parking lot, a vehicle storage place such as a home garage, or the like. In this case, it is preferable that the accumulator 20 can be replenished with compressed air in accordance with the charging time of the battery unit. For example, charging by a quick charger installed in a highway service area, a gas station, or the like is performed in a relatively short time of 15 minutes to 30 minutes. When a compressor as a compressed air supply source is provided in such a charging facility for quick charging, a compressor having a relatively large supply amount per unit time accordingly is required. On the other hand, charging by a charging facility for normal charging installed in a home garage or the like is usually performed for a long time of 5 hours or more. When a compressor as a compressed air supply source is provided in such a charging facility for normal charging, a compressor having a relatively small supply amount per unit time may be sufficient.

Next, vehicle height adjustment of the vehicle 1 by the air suspension device 10 will be described.

When the vehicle 1 is used, for example, the vehicle height may be lowered using the air suspension device 10 at the time of getting on and off the vehicle to thereby improve ease of getting on and off the vehicle for the occupant. In the vehicle 1, the accumulator 20 can store compressed air for performing vehicle height adjustment by the air suspension device 10 at least twice. Therefore, for example, at the time of commuting, going to hospital, shopping to a commercial facility, or the like, it is possible to adjust the vehicle height of the vehicle 1 once at each of departure place and destination.

When the vehicle height of the vehicle 1 is to be adjusted, an amount of compressed air in the air chamber A of the air spring 12 is adjusted using the on-off control valve 50. Specifically, when the vehicle height of the vehicle 1 is to be increased, the solenoid S1 of the on-off control valve 50 is energized so that the first port P1 and the second port P2 communicate with each other. As a result, compressed air is supplied from the accumulator 20′ to the air spring 12. Then, the air chamber A expands, the air spring 12 and the damper 11 extend, and the distance between the vehicle body B and the wheels W increases. In this way, the vehicle height of the vehicle 1 can be made higher than the state before compressed air is supplied.

When the vehicle height of the vehicle 1 is to be lowered, the solenoid S2 of the on-off control valve 50 is energized so that the first port P1 and the third port P3 communicate with each other. As a result, compressed air is discharged from the air spring 12 to the outside. Then, the air chamber A contracts, the air spring 12 and the damper 11 contract, and the distance between the vehicle body B and the wheels W decreases. In this manner, the vehicle height of the vehicle 1 can be made lower than the state before the compressed air is discharged.

As described above, according to the vehicle 1 of Embodiment 1, compressed air to be supplied to the air suspension device 10 as a pneumatic apparatus is supplied from the accumulator 20. The compressed air to be stored in the accumulator 20 is generated by the air pump 30. The air pump 30 is driven by a relative movement between the vehicle body B and the wheels W. Therefore, the vehicle 1 of Embodiment 1 can generate compressed air to be used for the air suspension device 10 without mounting a compressor as in the conventional case. Further, the air pump 30 is driven by the relative movement between the vehicle body B and the wheels W, so that the air pump 30 can have a simple configuration as compared with that of a compressor driven by electric power or the like. As a result, the weight of the vehicle 1 can be reduced as compared with that of a vehicle equipped with a compressor.

Therefore, the vehicle 1 of Embodiment 1 can suppress an increase in weight.

Further, the vehicle 1 is an electric vehicle. Since the vehicle 1 does not need to be equipped with a compressed air generation means such as a compressor for generating compressed air and also does not need electric power for driving the compressed air generation means, it is possible to suppress power consumption in the vehicle as compared with the case of a vehicle including a compressed air generation means. As a result, the vehicle 1 can use more electric power to drive a traveling motor as an electric vehicle, so that the traveling distance can be expanded. In addition, as compared with the case where a compressed air generation means is provided, it is possible to avoid an increase in weight associated with the compressed air generation means and contribute to weight reduction, so that it is possible to further improve the traveling distance.

In addition, the vehicle 1 of Embodiment 1 includes the terminal 40 as a supply unit that supplies compressed air to be stored in the accumulator 20 from the outside of the vehicle 1. Therefore, it is possible to quickly supply compressed air, for example, when the vehicle 1 runs out of compressed air. Further, even when the amount of compressed air generated by the air pump 30 is smaller than the amount of compressed air consumed by the air suspension device 10 as a pneumatic apparatus, the air suspension device 10 can be continuously used by supplying compressed air from the terminal 40 as needed.

In the vehicle 1 of Embodiment 1, the pneumatic apparatus according to the present invention is the air suspension device 10 having a vehicle height adjustment function. The accumulator 20 can store the compressed air for performing vehicle height adjustment by the air suspension device 10 at least twice. Therefore, the vehicle 1 can sufficiently exhibit the function of the air suspension device as needed, for example, in such a manner that first vehicle height adjustment is performed when departing to the destination and second vehicle height adjustment is performed when departing from the destination.

Further, in the vehicle 1, since the air pump 30 is disposed between the vehicle body B and the wheels W, it is possible to adopt a configuration in which the air pump 30 is driven by directly receiving a relative movement between the vehicle body B and the wheels W. As a result, the drive form of the air pump 30 can be easily configured, and the weight of the vehicle can be further reduced.

The present invention is not limited to Embodiment 1 explained with reference to the above description and drawings. For example, the following embodiments are also included in the technical scope of the present invention.

(1) In Embodiment 1, the air suspension device has been exemplified as a pneumatic apparatus, but the pneumatic apparatus according to the present invention is not limited thereto, and may be another pneumatic apparatus. The pneumatic apparatus according to the present invention is intended to broadly include, for example, those which use compressed air, such as a tire which is simply filled with compressed air.

(2) In Embodiment. 1, the form in which the vehicle includes the air suspension device as a pneumatic apparatus and the air suspension. device has the vehicle height adjustment function has been exemplified. However, even when the vehicle includes the air suspension device, the air suspension device does not necessarily have the vehicle height adjustment function.

(3) In Embodiment 1, the form in which the vehicle includes the on-off control valve has been exemplified, but the vehicle according to the present invention does not necessarily include an on-off control valve. Even when an on-off control valve is provided, the form thereof is not limited to the on-off control valve exemplified in Embodiment 1. Further, the vehicle according to the present invention may include, for example, a check valve that blocks a flow of compressed air from the air suspension device side to the accumulator side, instead of the on-off control valve.

(4) In Embodiment 1, as the amount of the compressed air to be stored in the accumulator, the form in which compressed air can be stored in an amount that allows the vehicle height adjustment of the vehicle to be performed by the air suspension device at least twice has been exemplified. However, the internal volume of the accumulator and the pressure of the compressed air that can be stored in the accumulator are not limited to those of the above-described embodiment. When the accumulator adjusts the vehicle height of the vehicle by the air suspension device, the amount of the compressed air to be stored in the accumulator may be an amount which allows the vehicle height adjustment to be performed once or three or more times.

(5) In Embodiment 1, the electric vehicle having the battery unit has been exemplified as a vehicle, but the vehicle according to the present invention is not limited thereto. For example, the vehicle according to the present invention may be a vehicle driven by an internal combustion engine such as a gasoline vehicle or a diesel vehicle, or a hybrid vehicle. In addition, another form of electric vehicle, such as a fuel cell vehicle, may be used.

(6) In Embodiment 1, the form in which the air pump is disposed between the vehicle body and the wheels has been exemplified, but another form, for example, in which the air pump is disposed on the vehicle body side and is driven by a relative movement with the wheels transmitted via a power transmission means such as a link mechanism may be used. Thus, the configuration, arrangement position, and the like of the air pump are not particularly limited as long as the air pump is driven by the relative movement between the vehicle body and the wheels and generates the compressed air to be stored in the accumulator.

(7) In Embodiment 1, the reciprocating air pump in which the piston reciprocates in the cylinder has been exemplified as the air pump, but this configuration is not essential in the air pump according to the present invention. The air pump may be, for example, another form of reciprocating pump such as a diaphragm type, or may be another style of air pump such as a rotary pump of a vane type, a gear type, or the like. Note that the air pump according to the present invention may have a configuration in which a drive resistance of the pump such as a resistance when generating compressed air acts as a part of a damping force in the suspension device, or may have a small-scale configuration in which an influence of the drive resistance of the pump is minimized.

(8) In Embodiment 1, the form in which the vehicle includes the terminal as a supply unit that supplies the compressed air to be stored in the accumulator from the outside of the vehicle has been exemplified, but the vehicle of the present invention does not necessarily include the supply unit.

### REFERENCE SIGNS LIST

1 Vehicle
10 Air suspension device (pneumatic apparatus)
11 Damper
11A Rod
11B Cylinder
12 Air spring
12A Chamber
12B Diaphragm
20 Accumulator
30 Air pump
31 Cylinder
32 Piston
32A Check valve
33 Rod
34, 35 Check valve
40 Terminal (supply unit)
40A Check valve
50 on-off control valve
60 External terminal
A Air chamber
B Vehicle body
R1 Piston-side chamber
R2 Rod-side chamber
W Wheel

1. A vehicle comprising:
a pneumatic apparatus to which compressed air is supplied;
an accumulator that stores compressed air to be supplied to the pneumatic apparatus; and
an air pump that is driven by a relative movement between a vehicle body and wheels and generates compressed air to be stored in the accumulator.

2. The vehicle according to claim 1, wherein the vehicle is an electric vehicle.

3. The vehicle according to claim 1, further comprising a supply unit that supplies the compressed air to be stored in the accumulator from outside of the vehicle.

4. The vehicle according to claim 2, further comprising a supply unit that supplies the compressed air to be stored in the accumulator from outside of the vehicle.
